(19) United States
(12) Patent Application Publication
(10) Pub. No.: US 2025/0136462 A1
(43) Pub. Date: May 1, 2025

(54) Amorphous Sodium Aluminate

(71) Applicant: USALCO LLC, Baltimore, MD (US)

(72) Inventors: James M. Dulko, Annapolis, MD (US); Erik W. Vukcevich, Baltimore, MD (US); Steven P. Cronin, Pikesville, MD (US)

(21) Appl. No.: 18/932,300

(22) Filed: Oct. 30, 2024

Related U.S. Application Data
(60) Provisional application No. 63/546,437, filed on Oct. 30, 2023.

(51) Int. Cl. C01F 7/04

(52) U.S. Cl. CPC C01F 7/04

(57) ABSTRACT

A method for producing an amorphous sodium aluminate includes providing a solution of sodium hydroxide, adding aluminum oxide trihydrate, a carbonate and a gluconate to the sodium hydroxide solution to form a second solution, and heating the second solution to a temperature sufficient to form the sodium aluminate. An amorphous sodium aluminate product produced by the process is also described. PAC or PACS produced with the amorphous sodium aluminate is also described.

### CROSS-REFERENCE TO RELATED APPLICATIONS

This application claims the benefit of U.S. Provisional Patent Application No. 63/546,437, filed Oct. 30, 2023, the disclosure of which is incorporated herein by reference in its entirety.

### TECHNICAL FIELD

The present invention relates to sodium aluminate solutions, and more particularly to highly stable and clear sodium aluminate solutions that form viscous concentrates upon evaporation and inhibit the formation of hard crystalline precipitates.

### BACKGROUND ART

Sodium aluminate is versatile and has several important uses. Sodium aluminate is used in the manufacture of catalysts and poly aluminum chlorides, used to soften water, used as a coating for titanium dioxide and is effective at removing phosphorous from water. The use of sodium aluminate has often been limited due to the stability of the product. Numerous attempts have been made to stabilize the product with some success. Sodium aluminate solutions go unstable by forming colloidal particles that cause turbidity in the solution. These colloidal particles can cause quality issues in products like poly aluminum chloride or catalysts. The colloidal particles harden and form various crystal forms of sodium aluminate and aluminum oxides. These crystalline species block pipes and seed further crystal growth on various components. These crystals are extremely difficult to remove from the components and often require replacing blocked pipes, valves, pumps and chiseling out storage vessels. Eliminating these crystals is extremely difficult. One way to dissolve the crystals is by adding sodium hydroxide to the crystals and boiling, bringing the solution to a high sodium oxide to aluminum oxide molar ratio or digesting with acids.

Sodium aluminate may be viscous and is often diluted at the point of use. Dilution accelerates the instability of sodium aluminate solution, causes these hard crystals to form, and causes production issues. U.S. Pat. No. 3,656,889 describes using tartaric, gluconic acids and their sodium salts to stabilize sodium aluminate solutions.

U.S. Pat. No. 6,800,264 to Askew et al. describes a process of using soda ash (sodium carbonate) and sodium gluconate to stabilize the sodium aluminate. The sodium carbonate is added from about 0.05% to 10% sodium carbonate. The sodium carbonate is added after the batch of sodium aluminate is made and then reboiled. In the Examples, the sample with the lowest concentration of sodium carbonate, which was 0.10 wt % (see Example 8), became opaque within a week and drops out precipitate within 2 weeks. At concentrations of greater than 25% aluminum oxide, the sodium carbonate crystallizes out at concentrations greater than 1% within 24 hours.

CN111217383A describes a grinding, precipitating process that takes at least 3 days to produce. CN110697747A reacts for 2-4 hours to produce a sodium oxide to aluminum oxide ratio of 2:1. CN105016366A describes a process that takes a minimum of 3.5 hours and adds ingredients of questionable toxicity. CN103787387A describes a process of ageing sodium aluminate having a sodium oxide to aluminum oxide ratio of 1.5:1 with gluconic acid and sodium gluconate. Typically, stable sodium aluminate solutions have a sodium oxide to aluminum oxide ratio of 1.5:1 with gluconic acid and sodium gluconate. Commercial, stable sodium aluminates typically have a concentration of 20% aluminum oxide. The above processes can be energy intensive, time consuming, produce low concentration, high sodium to aluminum mole ratios, cloudy, and unstable sodium aluminates.

### SUMMARY OF THE EMBODIMENTS

In accordance with one embodiment of the invention, a method for producing an amorphous sodium aluminate includes providing a solution of sodium hydroxide and adding aluminum oxide trihydrate, a carbonate and a gluconate to the sodium hydroxide solution to form a second solution. The method further includes heating the second solution to a temperature sufficient to form the sodium aluminate.

In related embodiments, the method further includes adding a bicarbonate to the second solution before heating. Preferably, the bicarbonate may be sodium bicarbonate and/or potassium bicarbonate. The bicarbonate may be greater than 0 wt % to about 0.1 wt % of the second solution. Preferably, the gluconate may be sodium gluconate and/or potassium gluconate. The gluconate may be about 0.01 wt % to about 0.25 wt % of the second solution. Preferably, the carbonate may be sodium carbonate and/or potassium carbonate. The carbonate may be about 0.02 wt % to about 1.0 wt % of the second solution. The method may further include adding water to the second solution before or after the heating. The method may further include adding potassium hydroxide to the solution of sodium hydroxide or to the second solution before or after the heating. The method may further include heating the sodium hydroxide solution before adding the aluminum oxide trihydrate, the carbonate and the gluconate and then continuing to heat the second solution to the temperature sufficient to form the amorphous sodium aluminate. The second solution may be heated to near, at or above a boiling point of the second solution. Preferably, the heating of the second solution may be between about 230° F. to about 255° F. The method may further include filtering the sodium aluminate after heating to remove any insoluble material. The sodium aluminate may have a sodium oxide to aluminum oxide ratio of about 1.190:1 to about 1.622:1. The sodium aluminate may have about 17.5 wt % to about 22.0 wt % sodium oxide. The sodium aluminate may have about 19.4 wt % to about 29.0 wt % aluminum oxide. The sodium aluminate may have about 0.02 wt % to about 1.0 wt % sodium carbonate, about 0.01 wt % to about 0.25 wt % sodium gluconate, and about 0.02 wt % to about 0.1 wt % sodium bicarbonate.

In accordance with another embodiment of the invention, an amorphous sodium aluminate is produced according to any of the methods mentioned above.

In accordance with another embodiment of the invention, a method for producing a stable, low concentration sodium aluminate includes producing the sodium aluminate according to any of the methods mentioned above having a designated percent concentration and adding the sodium aluminate to a solution of water to form a sodium aluminate solution to produce a lower concentration sodium aluminate, the lower concentration sodium aluminate having a lower percent concentration than the sodium aluminate with the designated percent concentration.

In related embodiments, the method further includes adding sodium hydroxide and/or potassium hydroxide to the sodium aluminate solution before heating. The sodium aluminate may have a concentration of about 47% sodium aluminate and the lower concentration sodium aluminate may have a concentration ranging from about 38% to about 45% sodium aluminate. The method may further include heating the sodium aluminate solution to near, at or above a boiling point of the sodium aluminate solution.

In accordance with another embodiment of the invention, a method for producing polyaluminum chlorides (PAC) suitable for use as coagulants in water treatment includes producing the sodium aluminate according to any of the methods mentioned above, adding the sodium aluminate to a solution of water to form a sodium aluminate solution, and mixing the sodium aluminate solution with a solution comprising basic aluminum chloride to produce a solution of the PAC.

In accordance with another embodiment of the invention, a method for producing polyaluminum chlorosulfates (PACS) suitable for use as coagulants in water treatment includes producing the sodium aluminate according to any of the methods mentioned above, adding the sodium aluminate to a solution of water to form a sodium aluminate solution, and mixing the sodium aluminate solution with a solution comprising basic aluminum chlorosulfate to produce a solution of the PACS.

### BRIEF DESCRIPTION OF THE DRAWINGS

The foregoing features of embodiments will be more readily understood by reference to the following detailed description, taken with reference to the accompanying drawings, in which:

FIG. 1 shows a process of producing an amorphous sodium aluminate according to embodiments of the present invention;

FIG. 2 is phase diagram for a sodium oxide, aluminum oxide and water system; and

FIG. 3 is a graph showing sodium aluminate reaction with CO₂ versus time for Examples 39-43 according to embodiments of the present invention.

### DETAILED DESCRIPTION OF SPECIFIC EMBODIMENTS

Definitions. As used in this description and the accompanying claims, the following terms shall have the meanings indicated, unless the context otherwise requires:

As used herein, mole ratio is the molar ratio of sodium oxide and potassium to aluminum oxide expressed as a ratio of sodium oxide to aluminum oxide. The mole ratio may be determined by:

(wt % alkali as sodium oxide÷wt % aluminum oxide)×(MW aluminum oxide÷MW sodium oxide)
where MW is molecular weight,
MW of aluminum oxide (Al₂O₃) is 101.96 g/mol,
MW of sodium oxide (Na₂O) is 61.979 g/mol, and
MW aluminum oxide÷MW sodium oxide is 1.645.

Carbonate may be any source of economically available carbonate. Preferred examples are sodium carbonate (Na₂CO₃) (also known as soda ash) and/or potassium carbonate (K₂CO₃). The carbonate may be used in various forms, e.g., hydrated, dense, light, or anhydrous.

Bicarbonate may be sodium bicarbonate (NaHCO₃) (also known as baking soda) and/or potassium hydrogen carbonate (KHCO₃) (also known as potassium bicarbonate).

Gluconate may be sodium gluconate and/or potassium gluconate. Gluconic acid may also be used as it forms sodium gluconate when added to the sodium hydroxide solution.

Aluminum oxide trihydrate (ATH) (also known as aluminum hydroxide) has a formula Al₂O₃-3H₂O. Examples were made using wet cake which has a typical moisture of 6%.

RO water refers to deionized water prepared by reverse osmosis or other membrane filtration processes.

Tap water refers to municipally treated water.

Soft water refers to water that has the minerals replaced by sodium ions in a water softening process.

50% Caustic Soda solution is a 50-weight percent commercially available sodium hydroxide solution.

Potassium hydroxide (KOH) (also known as caustic potash) can be dry at typically 85% strength or available as a solution of either 45% or 50%.

Turbidity is a parameter used to judge clarity in solutions. Turbidity is measured using a nephelometer that measures the light that passes through a specific width of solution. Turbidity results are given in Nephelometric Turbidity Units (NTUs) and Formazin Nephelometric Units (FNUs). Many standards define clear as being less than 50 NFUs or NTUs. Less than 10 FNUs or NTUS may be considered crystal clear.

Embodiments of the present invention address how to produce sodium aluminate using less energy at a lower sodium oxide to aluminum oxide ratio and how to prevent sodium aluminate from becoming unstable. Sodium aluminate made by prior art methods typically tries to stabilize sodium aluminate after it has been made. Embodiments of the present invention stabilize the sodium aluminate as it is being made. Small amounts of carbonates and optionally bicarbonates may catalyze the reaction of sodium hydroxide with aluminum oxide trihydrate (ATH), so the reaction takes less energy to form the sodium aluminate. Colloidal species are digested, and filtration time is reduced. A small amount of sodium gluconate may be added, as it chelates metals commonly found in water, such as iron, calcium and magnesium, that might cause instability. Embodiments of the present invention produce sodium aluminates that are stable for months, with solutions remaining crystal clear. When the sodium aluminates finally destabilize, they form amorphous particles that are easily suspended in solution and removed by pumping. Diluted solutions remain stable for days, as opposed to hours with conventionally made sodium aluminates. Diluted solutions form amorphous particles when instability eventually occurs. These amorphous particles are easily washed out of tanks and pipes instead of having to be chiseled out.

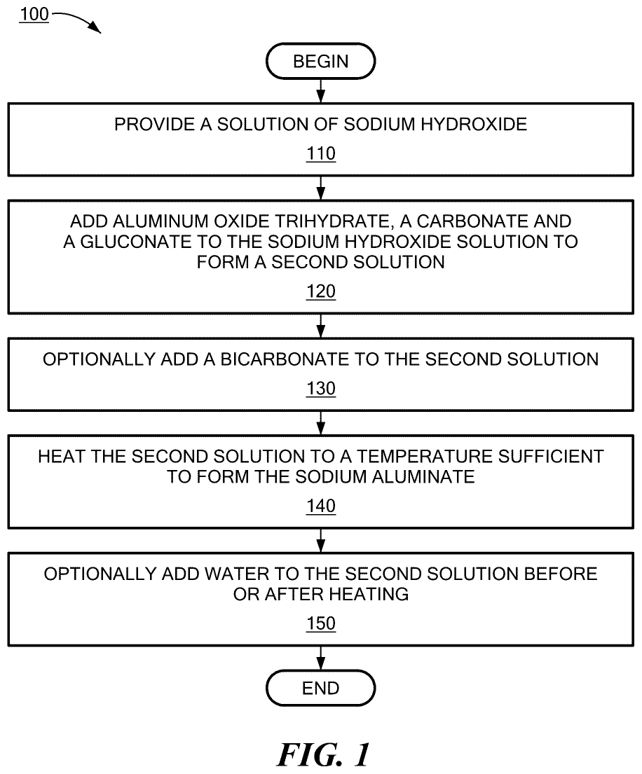

FIG. 1 shows a process 100 of producing an amorphous sodium aluminate according to embodiments of the present invention. The process begins at step 110, which provides a solution of sodium hydroxide. In step 120, aluminum oxide trihydrate (ATH) is added to the sodium hydroxide solution to form a second solution. When the ATH is digested in the sodium hydroxide solution, the rate at which the ATH is digested is dependent on the mole ratio of sodium hydroxide to aluminum oxide. The higher the sodium oxide to aluminum oxide ratio the faster the digestion. When the last amount of ATH is being added to the second solution, the digestion slows significantly as the sodium oxide ratio to aluminum oxide ratio is at the lowest point of the process. Digestion takes longer to complete when achieving mole ratios of less than 1.25.

The addition of carbonate is the main additive for stability and energy reduction in embodiments of the present invention. The carbonate may be any source of economically available carbonate. For example, carbonate may be sodium carbonate (Na₂CO₃) and/or potassium carbonate (K₂CO₃). The carbonate may be used in various forms, e.g., hydrated, dense, light, or anhydrous. Preferably, carbonate is used in an amount of about 0.02 wt % to about 1.0 wt % of the second solution.

Gluconate may be added at any time during this reaction. Preferably, the gluconate is added at the beginning of the process to prevent the formation of undesirable species. Gluconate may be sodium gluconate and/or potassium gluconate. Gluconic acid may also be used as it forms sodium gluconate when added to the sodium hydroxide solution. The amount of gluconate added is dependent on the use of the product. If the sodium aluminate is used to make alumina catalyst, a smaller amount is advantageous to use because large amounts of gluconate can interfere with the formation of ideal species. If trying to inhibit precipitation in dilute solutions, a greater amount of gluconate may be advantageous to use. Preferably, gluconate is used in an amount of about 0.01 wt % to about 0.25 wt % of the second solution in embodiments of the present invention. In the prior art, sodium gluconate is added to stabilize the sodium aluminate so much larger quantities are typically required. In embodiments of the present invention, gluconate is added to chelate the metals typically found in water, such as iron, calcium, and magnesium, and not to stabilize the sodium aluminate, so a very small amount is required.

In step 130, a bicarbonate may optionally be added to the second solution. The bicarbonate may be sodium bicarbonate and/or potassium bicarbonate. Very small quantities of bicarbonate inhibits the formation of particles in the solution, which increases the turbidity as the sodium aluminate ages. As little as about 0.02 wt % of bicarbonate is enough to prevent particle formation, which prevents an increase in the turbidity of the solution. At quantities greater than about 0.1 wt %, the bicarbonate is more difficult to dissolve and can precipitate out in the solution, causing an increase in turbidity. Higher quantities of sodium bicarbonate will lengthen the time for dissolution and the solution will be more difficult to filter.

In step 140, the second solution is heated to a temperature sufficient to cause the sodium aluminate to form. For example, the second solution may be heated to near, at or above the boiling point of the second solution. Preferably, the second solution is heated between about 230° F. to about 255° F. Heating the second solution at a low boil or close to the boiling point maximizes the reaction rate without generating too much wasteful steam. The sodium hydroxide solution may be heated before adding the ATH, the carbonate and the gluconate. In this case, the heating may continue while the ATH, the carbonate and the gluconate are added to the sodium hydroxide solution and then the heating continues at a temperature sufficient to form the sodium aluminate.

Another method of stabilizing sodium aluminates includes the addition of potassium hydroxide and/or potassium salts. Potassium hydroxide has a Molar mass of 56.11 g/mol while sodium hydroxide has a molar mass of 39.99 g/mol. Therefore, more than 40% more potassium hydroxide is needed than sodium hydroxide to make the same molar ratio of aluminate. Since the cost of potassium hydroxide is more expensive than sodium hydroxide, sodium aluminate is more economical to make and has acceptable functionality compared to potassium aluminate. However, small amounts of potassium hydroxide, carbonate or bicarbonate may be used to stabilize sodium aluminate solutions. Potassium hydroxide is a much smaller molecule than sodium hydroxide and is more corrosive and holds onto water more strongly. The more corrosive nature of potassium hydroxide can aid in breaking down organic matter that may trap phosphorous. The ability to hold onto water more strongly makes solutions of sodium aluminate more difficult to crystalize. The addition of KOH may allow sodium aluminates of lower concentration to be stable at lower mole ratios. The potassium hydroxide and/or potassium salts may be added to the solution of sodium hydroxide, may be added to the second solution or both.

Preferably, the sodium carbonate and optional bicarbonate is added to the initial digestion of aluminum oxide trihydrate in the sodium hydroxide solution or may be added later on as the reaction proceeds. During the ATH digestion, the carbonate and optional bicarbonate dissolve proportionately with the ATH. By adding carbonate and optional bicarbonate with the ATH initially, those molecules can be built into the aluminate structure and cause an amorphous aluminate to be formed. The early addition of carbonate and optional bicarbonate aids in the digestion, shortening the digestion time and reducing the amount of time and energy necessary to digest the ATH. When the digestion is finished, the carbonates and optional bicarbonates are dissolved. This is important because undissolved microcrystals of ATH are believed to cause sodium aluminate instability. More time and energy are then needed to dissolve these microcrystals of ATH. Embodiments of the present invention eliminate the additional step of heating the sodium aluminate solution after the sodium aluminate is formed and adding carbonate until the solution clears, which wastes energy and hours of time while this process occurs.

In step 150, water is optionally added to the second solution before or after heating the second solution and/or heating the sodium hydroxide solution.

While not wishing to be bound by any theory, the stabilization of the sodium aluminate may be caused by the carbonate and optional bicarbonate molecules interfering with the crystalline formation of sodium aluminate compounds. These molecules may trap water into the sodium aluminate molecule, preventing crystal growth. Carbon dioxide is known to destabilize sodium aluminate. The carbon dioxide molecule displaces a hydroxide in the sodium aluminate molecule. This species of sodium carbo aluminate is unstable and drives crystal growth. In the highly alkaline solution of sodium aluminate, the optional bicarbonate and carbonate, such as sodium bicarbonate and sodium carbonate, may have difficulty disassociating and may interfere with the crystallization process by absorbing water into the sodium aluminate molecule. At higher sodium oxide to aluminum oxide ratios, stability and clarity are easier to achieve. When the sodium oxide to aluminum oxide ratio is lowered to around 1.2 or below, clarity and stability are difficult to achieve. These lower mole ratios need the optional bicarbonate addition to maintain clarity and stability. Many applications for sodium aluminate require soluble aluminum and the sodium hydroxide is a waste that needs to be neutralized, which creates waste.

Products formed according to embodiments of the present invention remain crystal clear for months with a sodium carbonate concentration of less than 0.1% sodium carbonate and, optionally, at least 0.02% sodium bicarbonate.

In another embodiment of the present invention, lower concentration sodium aluminates may be made more stable by first producing the higher concentration, lower mole ratio sodium aluminate and then adjusting the concentration lower, with or without adjusting the mole ratio higher. This provides lower viscosity products useful for various applications. For example, the sodium aluminate is made according to embodiments of the present invention having a designated percent concentration. The sodium aluminate is then added to a solution of water to form a sodium aluminate solution. The sodium aluminate solution is heated to near, at or above a boiling point of the sodium aluminate solution to produce a lower concentration sodium aluminate than the initial sodium aluminate with the designated percent concentration. As described in Examples 26-29 below, samples were produced and then adjusted to the desired mole ratio and concentration.

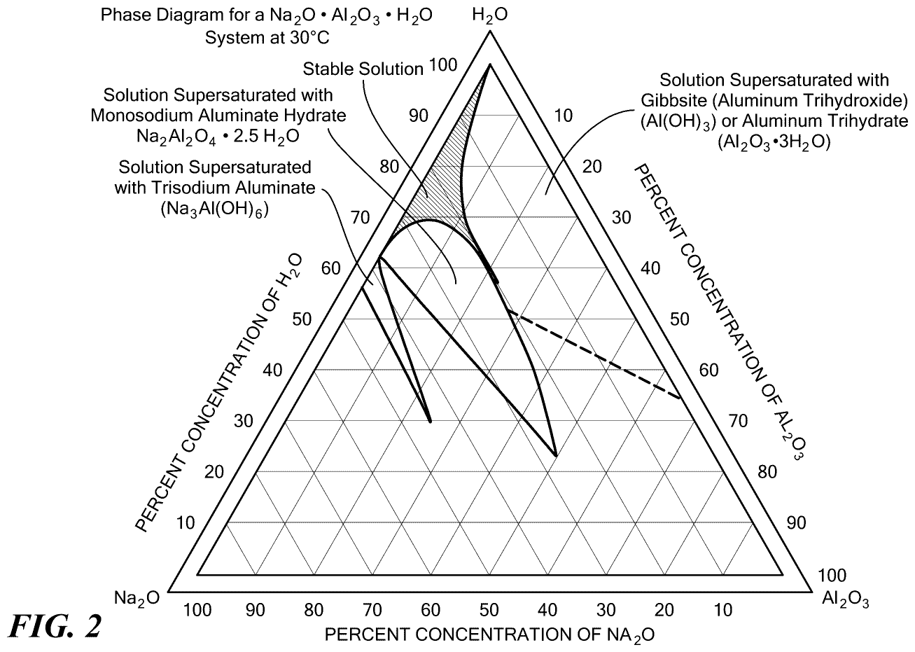

Sodium aluminate stability follows a stability curve that can be found on phase diagrams, such as shown in FIG. 2. Sodium aluminate is typically sold as a 45% solution with a 1.28 mole ratio, 43% solution with a 1.35 mole ratio, and 38% solution with a 1.5 mole ratio. If sodium aluminate deviates much from the above relationships, the sodium aluminate tends to become unstable.

In another embodiment of the present invention, a method for producing polyaluminum chlorides (PAC) or polyaluminum chlorosulfates (PACS) suitable for use as coagulants in water treatment using the amorphous sodium aluminate according to embodiments of the present invention is disclosed. The process involves mixing a solution comprising sodium aluminate according to embodiments of the present invention with a solution comprising either basic aluminum chloride (if the desired product is a polyaluminum chloride (PAC)) or basic aluminum chlorosulfate (if the desired product is polyaluminum chlorosulfate (PACS)). These solutions may be mixed under conditions of sufficiently high shear to prevent gel formation and the reaction temperature may be maintained below 50° C. When the reaction is carried out under these conditions, a non-viscous milky suspension is produced which clears with time. The temperature of the milky suspension may be gradually increased until a clear product solution is obtained. The reaction between the sodium aluminate according to embodiments of the present invention and either basic aluminum chloride or basic aluminum chlorosulfate may be carried out at or below 40° C. and mixing may occur in the presence of a velocity gradient of at least 1000 reciprocal seconds. For reactions in which the basicity of the product is to be 70% or less, a small amount, e.g., preferably less than 1%, of calcium carbonate may be added to the solution of basic aluminum chloride or basic aluminum chlorosulfate before mixing with the sodium aluminate according to embodiments of the present invention. The addition of calcium carbonate to reactions which form products of greater than 70% basicity is entirely optional.

The basic aluminum chloride or basic aluminum chlorosulfate used as a reactant in the process can be made using a variety of methods well-known in the art. The preferred method for producing basic aluminum chloride is to react a source of aluminum oxide trihydrate with hydrochloric acid or a combination of hydrochloric acid and phosphoric acid. In the case of basic aluminum chlorosulfate, a source of aluminum oxide trihydrate may be reacted with hydrochloric acid and sulfuric acid. The polyaluminum chloride or polyaluminum chlorosulfate produced as described above may be used in another reaction with the sodium aluminate according to embodiments of the present invention, in cases where very high basicity products are desired. The mixing of reagents may takes place at a shear force high enough to prevent gel formation, preferably in the presence of a velocity gradient of at least 1000 reciprocal seconds. When preparing polyaluminum chlorides of between 50% and 70% basicity, preparations may be mixed at a temperature below 60° C. For products of greater than 70% basicity, mixing may take place at a temperature of greater than 60° C. in order to prevent gel formation. However, a product of greater than 70% basicity may be obtained in reactions carried out below 60° C. by reducing the rate at which sodium aluminate is added to the reaction and by increasing the shear. The resulting milky suspension may be heated to produce a clear product or allowed to clear over time without additional heat being applied. The reaction between polyaluminum chloride or polyaluminum chlorosulfate and the sodium aluminate according to embodiments of the present invention may be used to increase the basicity of polyaluminum chlorides and polyaluminum chlorosulfates made by other processes.

### EXAMPLES

Examples 1-17 are described in Table 1. Weights and percentages are given in the table. All batches were stored in non-airtight containers.

TABLE 1

| | | | | | Sodium | | % Sodium | | | | | | |
|---|---|---|---|---|---|---|---|---|---|---|---|---|---|
| | 50% | | Sodium | Sodium | Bicar- | % Sodium | Bicar- | % Sodium | Initial | Analysis | | | Water |
| Ex. # | Caustic | ATH | Gluconate | Carbonate | bonate | Carbonate | bonate | Gluconate | Water | Na₂O | Al₂O₃ | Na₂O/Al₂O₃ | Type |
| 1 | 232.3 | 167.5 | 0.25 | 0.2 | 0 | 0.04% | 0.00% | 0.050% | 99.8 | 17.89% | 20.72% | 1.420 | RO |
| 2 | 250.3 | 210.2 | 0.175 | 0.25 | 0.25 | 0.05% | 0.05% | 0.035% | 39 | 19.84% | 26.46% | 1.234 | RO |
| 3 | 250.3 | 210.2 | 0.175 | 0.25 | 0.15 | 0.05% | 0.03% | 0.035% | 39 | 19.59% | 26.05% | 1.237 | RO |
| 4 | 250.3 | 210.2 | 0.175 | 0.25 | 0.05 | 0.05% | 0.01% | 0.035% | 39 | 19.63% | 26.16% | 1.235 | RO |
| 5 | 246.5 | 210.2 | 0.175 | 0.25 | 0.05 | 0.05% | 0.01% | 0.035% | 43 | 19.13% | 25.88% | 1.216 | RO |
| 6 | 996.1 | 847.2 | 4.996 | 1 | 0.6 | 0.05% | 0.03% | 0.250% | 150.7 | 19.50% | 26.45% | 1.213 | RO |
| 7 | 247.7 | 195.5 | 0.5 | 0.25 | 0.15 | 0.05% | 0.03% | 0.100% | 56 | 19.01% | 23.54% | 1.329 | RO |
| 8 | 247.1 | 215.9 | 0.05 | 0.25 | 0.025 | 0.05% | 0.005% | 0.010% | 36.7 | 19.60% | 26.89% | 1.199 | RO |
| 9 | 247.1 | 215.9 | 0.25 | 0 | 0 | 0 | 0 | 0.050% | 36.8 | 19.19% | 26.19% | 1.205 | RO |
| 10 | 247.1 | 215.9 | 0.175 | 0.35 | 0.175 | 0.07% | 0.035% | 0.035% | 36.5 | 18.78% | 25.78% | 1.198 | Tap |
| 11 | 247.1 | 215.9 | 0.175 | 0.25 | 0.5 | 0.05% | 0.10% | 0.035% | 36.6 | 19.04% | 26.25% | 1.193 | RO |
| 12 | 247.1 | 215.9 | 0.25 | 0.25 | 0.15 | 0.05% | 0.03% | 0.050% | 50 | 19.15% | 26.50% | 1.189 | Tap |
| 13 | 267.1 | 228.1 | 0.25 | 0.25 | 0.15 | 0.05% | 0.030% | 0.050% | 4.3 | 19.97% | 26.98% | 1.217 | Tap |
| 14 | 252.9 | 215.9 | 0.25 | 5 | 0.15 | 1% | 0.03% | 0.050% | 26 | 19.61% | 26.63% | 1.211 | RO |
| 15 | 252.9 | 215.9 | 1.25 | 0.25 | 0.15 | 0.05% | 0.03% | 0.250% | 29.7 | 19.25% | 26.35% | 1.202 | Soft |
| 16 | 252.9 | 215.9 | 0.175 | 0.25 | 0.1 | 0.05% | 0.02% | 0.035% | 50 | 19.39% | 26.34% | 1.211 | Soft |
| 17 | 252.9 | 215.9 | 0.175 | 0.1 | 0.1 | 0.02% | 0.02% | 0.035% | 50 | 19.11% | 25.91% | 1.213 | Soft |

### Examples 1-7

Examples 1-7 were produced by heating a solution of sodium hydroxide, water, and gluconate to about 240° F. The sodium carbonate and sodium bicarbonate were added along with the ATH. Heat was maintained on the reaction vessel as the ATH is added. The reaction vessel was heated continuously until the solution was clear. The batch was then filtered to remove any insoluble material. Water was replaced as evaporation occurred. Soft water or RO water is preferably used as these waters lack calcium and magnesium that precipitate out. Harder waters can be used but an additional amount of sodium gluconate should be added to chelate the additional calcium and magnesium. All batches tested were less than 5 FNUS after filtration and remained less than 10 FNUS after 2 weeks.

### Example 1

This batch was made with no sodium bicarbonate but contained 0.04% sodium carbonate. The batch stayed fairly clear with a turbidity of 11.2 FNUs after 50 days. This batch demonstrates that the bicarbonate can be reduced if the mole ratio of sodium oxide to aluminum oxide is higher but may not be as economical at lower mole ratio sodium aluminates.

### Example 2

At 4 months, this batch had no precipitate and 60.0 FNU turbidity and was just slightly cloudy. This batch was made according to embodiments of the present invention.

### Example 3

This batch tested at 9.9 FNUs at 8 weeks and was still crystal clear. This batch was made according to embodiments of the present invention.

### Examples 4 & 5

These samples exceeded 50 FNUs after 2 months. Batches had only 0.01% sodium bicarbonate and were low mole ratio sodium aluminates. The batches had no precipitate but were fairly cloudy. This batch demonstrates that at low mole ratios additional sodium bicarbonate should be used to maintain clarity and stability.

### Example 6

This batch tested at 4.2 FNUs at 50 days. An alternative source of ATH was used.

### Example 7

This batch was made at a higher mole ratio demonstrating the benefit of embodiments of the present invention at lower concentrations and higher mole ratios. This batch tested at 8.9 FNUs at 50 days.

### Example 8

This batch turned orange within 24 hours demonstrating an insufficient amount of sodium gluconate was added.

### Examples 9-17

All batches tested were less than 5 FNUs after filtration and remained less than 10 FNUS after 2 weeks.

### Example 9

This batch was made without carbonate or bicarbonate. The process of this batch is comparative to current commercial techniques. Turbidity was 46 FNUs at 50 days. The batch did contain 0.05% sodium gluconate.

### Example 10

This batch was made with tap water instead of RO water and 0.035% sodium gluconate. The sample became cloudy, greater than 50 FNUs, within a month demonstrating that there was insufficient gluconate to chelate all the minerals in the tap water.

### Example 11

This batch was made with tap water and 0.035% sodium gluconate, 0.05% sodium carbonate and 0.1% sodium bicarbonate. The sample became cloudy, greater than 50 FNUs, within a month demonstrating that there was excess sodium bicarbonate in the batch. No precipitate was observed in the sample after 2 months.

### Example 12

This batch was made with tap water and 0.05% sodium gluconate, 0.05% sodium carbonate and 0.03% sodium bicarbonate. Tap water was used demonstrating that there was sufficient gluconate and not enough excess bicarbonate to cause turbidity. The sample was crystal clear, 4.8 FNUs at one month.

### Example 13

This batch was made at high concentration with very little water demonstrating that very high concentrations can be stable when made according to embodiments of the present invention. The sample was crystal clear, 3.1 FNUs at one month.

### Example 14

This batch was made with 1% sodium carbonate, 0.03% sodium bicarbonate and 0.05% sodium gluconate. This batch demonstrates that samples can be made with higher levels of sodium carbonate and remain stable and clear. Turbidity was 3.3 FNUs at 3 weeks.

### Example 15

This batch was made at high concentration with very little water demonstrating that very high concentrations can be stable using the process of this invention. The sample was crystal clear, 4.3 FNUs at 2 weeks.

### Example 16

Batch was made at high concentration with very little water demonstrating that very high concentrations can be stable when made according to embodiments of the present invention. The sample was crystal clear, 2.5 FNUs at 1 week.

### Example 17

This batch was made at high concentration with very little water demonstrating that very high concentrations can be stable when made according to embodiments of the present invention. The sample was crystal clear, 3.6 FNUs at 1 week.

### Example 18

To demonstrate the crystalline properties versus amorphous properties of sodium aluminate, samples of sodium aluminate were intentionally destabilized by the addition of carbon dioxide and water. In a narrow mouth 250 ml Erlenmeyer flask, 100 grams of Example 9, a control sample of sodium aluminate, was placed with a magnetic stir bar. In a separate flask, 100 grams of Example 12, a sample made according to embodiments of the present invention, was placed with a stir bar. Both flasks were stirred and carbonated with 10 psi of carbon dioxide until 0.3 grams of carbon dioxide were absorbed by the sodium aluminate solutions. Both flasks contained small amounts of precipitates. 100 grams of deionized water was added to each flask and the flasks were stirred for 5 minutes and then let to sit overnight. The next day both flasks contained a white precipitate below a clear solution. The flasks were emptied and filtered and washed. The flask that contained Example 12 was cleaned by rinsing with water from a wash bottle and gently rubbing with a plastic spatula. The control flask that contained Example 9 could not be cleaned with a plastic or metal spatula, but had to be cleaned by boiling the flask for 15 minutes with a 10% hydrochloric acid solution. The precipitate from the control sample was a mixture of clear crystals and amorphous white precipitate. The precipitate from the Example 12 sample, containing sodium aluminate made according to embodiments of the present invention, only contained amorphous powder.

### Example 19

A 10% sodium aluminate solution was made by mixing 20 grams of sodium aluminate solution with tap water in a beaker. Solutions were mixed for 3 minutes and then let to sit. This was done for control Example 9 and Example 6, made according to embodiments of the present invention. Example 6 showed no signs of precipitate for 3 days. The control sample, Example 9, precipitated in less than a day and the beaker had to be cleaned by scraping with a metal spatula to remove the crystalline precipitates. The amorphous precipitate of Example 6 was easily rinsed out with a wash bottle. No scraping was required.

### Example 20

In a porcelain dish, 5 grams of sodium aluminate solution was placed. The dishes were placed in an oven at 105° C. Example 6 and Control Example 9 were placed in the oven. After 24 hours, Control Example 9 dried into white hard crystals. Example 6 became a viscous residue with a thin layer of opaque material on the surface. Five days later, the dish with Example 6 remained the same, demonstrating the resistance of the amorphous sodium aluminate products made according to embodiments of the present invention to crystallization.

### Example 21

In a plastic 1¾ inch×1¾ inch weigh boat, 1 gram of sodium aluminate of Example 9, Example 2, Example 3, and Example 14 were placed. The samples were stirred twice a week for two months. Example 9, the control sample, developed hard crystals that were suspended in the solution and attached to the bottom of the dish. The other examples developed slight hazes on the surface, but no hard crystals attached to the dish nor were found suspended in the solution. This demonstrates that products made according to embodiments of the present invention inhibit crystal growth when exposed to air.

### Examples 22-25

Batches were made according to U.S. Pat. No. 6,800,264 to compare the sodium aluminate made according to the prior art versus sodium aluminate made according to embodiments of the present invention. Examples 22-25 were chosen as they demonstrated the best stability described in U.S. Pat. No. 6,800,264. Turbidities were measured a day after the sodium aluminate was made and are reported in Table 2 below.

TABLE 2

| | 6,800,264 | | | | Turbidity |
|---|---|---|---|---|---|
| Example | Ex. | % Al₂O₃ | % Na₂O | Stabilizer | (FNUs) |
| 22 | 3 | 26.0% | 19.5% | 1% Na₂CO₃ | 136 |
| 23 | 6 | 25.75% | 19.1% | 0.2% Na₂CO₃ | 243 |
| 24 | 7 | 27.5% | 20.5% | 0.4% Na₂CO₃ | 214 |
| 25 | 8 | 26.65% | 20.1% | 0.4% Na₂CO₃ | 140 |

### Examples 26-29

To demonstrate that the sodium aluminates made according to embodiments of the present invention can improve the stability of lower concentrations and can remain stable at lower concentration variations, an initial batch of 47% sodium aluminate was made and subsequently the mole ratio was raised, and the concentration was decreased to form very stable sodium aluminates.

### Example 26

In a 2-liter beaker, 855.5 g of 50% caustic soda was added with 110 grams of water. The solution was heated and stirred. 0.85 g of sodium carbonate, 0.51 g of sodium bicarbonate and 0.60 g of sodium gluconate was added to the solution. When the temperature reached 230° F., the addition of 734 grams of ATH was started. The solution was heated to just above boiling and maintained until a clear solution was obtained. This produced 1700 grams of 26.5% aluminum oxide, 19.5% sodium oxide sodium aluminate. Approximately 500 grams were removed and filtered to produce a highly stable, clear, and high concentration sodium aluminate solution.

### Example 27

To the rest of the solution of 1206.2 g of Example 26, 22.2 g of 50% caustic and 29.6 g of water was added and brought to a quick boil. About 500 grams of this solution was removed and filtered producing a 45% sodium aluminate solution with 25% aluminum oxide and 19.15% sodium oxide.

### Example 28

To the remaining solution of 771 g of Example 27, 22.7 g of 50% caustic and 46.8 g of water was added and was brought to a quick boil. Again, another approximate 500 grams of solution was removed and filtered producing a 43% sodium aluminate solution with 23.8% aluminum oxide and 19.3% sodium oxide.

### Example 29

To the remaining solution of 385.3 g of Example 28, 22.8 grams of 50% caustic and 37.8 grams of water was added and was brought a quick boil. This produced a clear stable 38% sodium aluminate solution of 20.5% Al₂O₃ and 18.5% sodium oxide.

Samples of Example 26-29 were tested for turbidity 2 months later and are described in Table 3.

TABLE 3

| Example | Strength | Turbidity (FNUs) |
|---|---|---|
| 26 | 47% | 8.0 |
| 27 | 45% | 3.8 |
| 28 | 43% | 2.8 |
| 29 | 38% | 3.7 |

### Example 30

To demonstrate substituting potassium salts for the sodium, 252.9 g of 50% caustic and 30.6 g of soft water was added in a 600 ml beaker. The solution was heated and stirred. 0.15 g sodium bicarbonate, 0.27 g potassium gluconate, and 0.38 g of potassium carbonate was added to the solution. When the solution reached 240° F., 215.9 g of ATH was added. The batch was heated until all the ATH was dissolved, and a clear solution was observed. The batch was filtered and produced a clear stable sodium aluminate. After 4 months, the solution had a turbidity of 9.3 FNUs.

### Example 31

Another example of substituting potassium salts for sodium, 252.9 g of 50% caustic and 30 g of soft water was added in a 600 ml beaker. The solution was heated and stirred. 0.38 g potassium carbonate, 0.18 potassium hydrogen carbonate, and 0.175 g sodium gluconate was added to the solution. When the solution reached 240° F., 215.9 g of ATH was added. The batch was heated until all the ATH was dissolved, and a clear solution was observed. The batch was filtered and produced a clear stable sodium aluminate. After 1 week, the solution had a turbidity of 5.2 FNUs.

### Example 32

This batch of sodium aluminate was made without the addition of water initially. 224.4 g of 50% sodium hydroxide was added to a 600 ml beaker with no water. The solution was heated and stirred. 0.336 of potassium carbonate, 0.126 g of sodium bicarbonate, and 0.147 g of sodium gluconate was added to the solution. 191.6 g of ATH was added to this solution while the solution was heating. The solution began to boil at about 250° F. and was allowed to boil until the temperature reached 255° F. RO water was added until the total batch weighed 476.6 g. This was 56.6 g of water to make the dilution plus water that had evaporated. This yielded a sodium aluminate solution of 18.6% Na₂O and 24.9% Al₂O₃ with a mole ratio of 1.229. After 1 week, the solution had a turbidity of 4.7 FNUs.

### Example 33

This batch of sodium aluminate was made without the addition of water initially, demonstrating that the solution is stable even without boiling. 187 g of 50% sodium hydroxide was added to a 600 ml beaker with no water. The solution was heated and stirred. 0.280 of potassium carbonate, 0.1050 g of sodium bicarbonate, and 0.1225 g of sodium gluconate was added to the solution. 159.7 g of ATH was added to this solution while the solution was heating. The solution was never allowed to boil. At 240° F., the solution was completely clear. The solution was allowed to reach 244° F. and then the heat was turned off and the solution allowed to cool. When the solution reached 220° F., 45.4 g of RO water was added to the solution in addition to the amount of water that evaporated. The resulting solution was 160° F. and was filtered. This yielded a sodium aluminate solution of 18.4% Na₂O and 25.4% Al₂O₃ with a mole ratio of 1.194. After 1 day, the solution had a turbidity of 11.2 FNUs and after 16 days 25.0 FNUs.

### Example 34

This batch of sodium aluminate was made by adding 322 g of 50% sodium hydroxide to a 1 L beaker with no water. The solution was heated and stirred. 0.24 g of sodium gluconate was added to the solution. 277.6 g of ATH was added to the solution while the solution was heating. The solution was never allowed to boil. At 240° F., the solution was completely clear. The solution was allowed to reach 244° F. and then the heat was turned off. 81 g of RO water was added to the solution in addition to the amount of water that evaporated, along with 3.3 g of potassium hydroxide at 85.9% and 0.7 g of sodium carbonate. The resulting solution was 160° F. and was filtered. This yielded a sodium aluminate solution of 18.7% Na₂O and 25.1% Al₂O₃ with a mole ratio of 1.222. After 11 days, the solution had a turbidity of 1.8 FNUs.

### Examples 35 & 36

This batch of sodium aluminate was made by adding 429.4 g of 50% sodium hydroxide to a 1 L beaker with no water. The solution was heated and stirred. 371.8 g of ATH was added to the solution while the solution was heating. 0.32 g of sodium gluconate and 0.9 g of sodium carbonate was added to the solution. The solution was never allowed to boil. At 235° F., the solution was completely clear. 107 g of tap water was added to the solution in addition to the amount of water that evaporated, along with 4.5 g of potassium hydroxide at 85.9%. The resulting solution was 160° F. and was filtered. This yielded a sodium aluminate solution of 909 g of 18.85% alkali as Na₂O and 25.6% Al₂O₃ with a mole ratio of 1.213 and a turbidity of 2.2 FNUs.

Four hundred and nine grams of this solution were separated and 22 g of KOH at 85.9% and 150 g of tap water was added to the solution. The solution was filtered and produced a sodium aluminate solution of 16.7% equivalent of sodium oxide and 20.3% aluminum oxide resulting in an equivalent mole ratio of 1.355 and a turbidity of 1.9 FNUs.

### Examples 37 & 38

This batch of sodium aluminate was made by adding 343.2 g of 50% sodium hydroxide to a 1 L beaker with no water. 21 g of KOH at 85.9% was added to the solution. The solution was heated and stirred. 371.8 g of ATH, 1.05 g of potassium carbonate and 0.28 g of sodium gluconate was added to the solution while the solution was heating. The solution was never allowed to boil. At 235° F., the solution was completely clear. 160 g of tap water was added to the solution in addition to the amount of water that evaporated. The resulting solution was filtered. This yielded a clear, sodium aluminate solution of 909 g of 18.1% alkali as Na₂O and 25.1% Al₂O₃ with a mole ratio of 1.184.

Four hundred and twenty-three grams of this solution were separated and 156 g of tap water and 51.6 of sodium hydroxide solution was added to the solution. The solution was filtered and produced a clear sodium aluminate solution of 17.5% equivalent of sodium oxide and 19.5% aluminum oxide resulting in an equivalent mole ratio of 1.478. These examples demonstrate that the KOH can be added early in the batch and finished off with sodium hydroxide and still produce a clear stable solution.

In Examples 37 and 38, the maximum KOH was 3% in the 47%, 2.3% in the 45% and 1.9% in the 38% solution. The concentration ranges go as low as 17.5% sodium oxide, 19.5% aluminum oxide and mole ratio as high as 1.478 in Example 38.

### Examples 39-43

This batch of sodium aluminate (SA) was made by the process of dissolving aluminum trihydrate (ATH) in a 50% caustic solution. In all cases, sodium gluconate was added to the solution. The other four samples were prepared by adding sodium carbonate (Na₂CO₃), sodium carbonate with sodium bicarbonate (NaHCO₃), potassium carbonate (K₂CO₃), and potassium carbonate with sodium bicarbonate.

No CO₃²⁻, HCO₃⁻
Caustic: 471.5 g
ATH: 421.9 g
Na Gluconate: 0.35 g
H₂O: 106 g
Yield: ˜1000 g
   With Na₂CO₃
Caustic: 704.5 g
Hydrate: 593.0 g
Na₂CO₃: 0.560 g
Na Gluconate: 0.7 g
H₂O: 101 g
Yield: ˜1,400 g
   With K₂CO₃
Caustic: 534.2 g
Hydrate: 456.2 g
K₂CO₃: 0.8 g
Na Gluconate: 0.35 g
H₂O: 9 g
Yield: ˜1,000 g
   With Na₂CO₃ and NaHCO₃
Caustic: 494.5 g
Hydrate: 422.0 g
Na₂CO₃: 0.50 g
NaHCO₃: 0.50 g
Na Gluconate: 2.51 g
H₂O: 80.5 g
Yield: ˜1,000 g
   With K₂CO₃ and NaHCO₃
Caustic: 534.2 g
Hydrate: 456.2 g
K₂CO₃: 0.80 g
NaHCO₃: 0.30 g
Na Gluconate: 0.35 g
H₂O: 9 g
Yield: ˜1,000 g

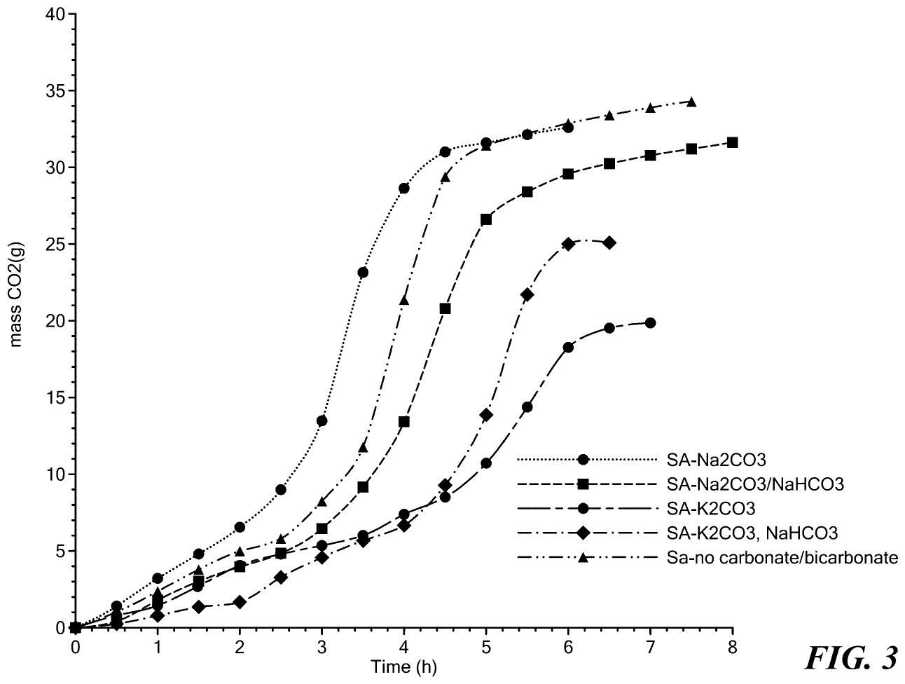

After dissolution, water was added to the solution and then filtered for use the next day. In each example, 250.0 g of the desired SA was placed in a Florence flask fitted with a stir bar. The flask was put under 1 atm of CO₂ and stirred continuously and the mass was recorded every 30 minutes, as shown in FIG. 3.

In the cases of SA-K₂CO₃ and SA-K₂CO₃, NaHCO₃, the solution solidified after max CO₂ addition. The addition of potassium, K+, ions slowed the adsorption of CO₂ into the SA. The adsorption of CO₂ follows the reaction shown below:

OH⁻+CO₂ [symbol] HCO₃⁻ (1)

HCO₃⁻ [symbol] CO₃²⁻+H⁺ (2)

Al(OH)₄⁻ [symbol] Al(OH)₃+OH⁻ (3)

Sodium ions, Na+, do not inhibit CO₂ adsorption as seen by the comparison of SA-Na₂CO₃ and SA-no carbonate/bicarbonate. However, the addition of HCO₃— slows down CO₂ adsorption, as it slows the equilibrium of reaction (1) shown above.

### Examples 44-45

This batch of sodium aluminate was made by the process of dissolving ATH in a 50% caustic solution. Sodium gluconate, sodium carbonate and sodium bicarbonate were added during the dissolution process. In a 2-liter beaker, 844 grams of 50% caustic soda solution was added with 717.6 g of ATH. 1.75 grams of soda ash and 0.53 grams of sodium bicarbonate was added to the slurry and the solution was heated to 250° F. and stirred on a hotplate. The solution never boiled. RO water was added to the solution to make a 45% sodium aluminate solution. The mostly clear solution was filtered, produced a batch of 1750 grams, and analyzed as
25.2 wt % Al₂O₃
18.7 wt % Na₂O
Mole ratio (Na₂O:Al₂O₃) 1.222

Concentrated solutions of sodium aluminate can become very viscous at lower temperatures so it is more practical to make lower concentrations for applications where a storage tank may be kept outside.

### Example 44

385 grams of the above sodium aluminate solution was added to a solution of 50 grams of 50% caustic soda and 65 grams of tap water. No heating was done.

This produced a clear solution that analyzed at
19.4 wt % Al₂O₃
18.3 wt % Na₂O
Mole ratio (Na₂O:Al₂O₃) 1.572

The solution remained clear after 100 days the turbidity was <1 FNU.

### Example 45

365 grams of the above sodium aluminate solution was added to a solution of 54 grams of 50% caustic soda and 81 grams of tap water. No heating was done. This produced a clear solution that analyzed at
18.1 wt % Al₂O₃
18.3 wt % Na₂O
Mole ratio (Na₂O:Al₂O₃) 1.622

The solution remained clear after 100 days the turbidity was <1 FNU.

### PACS Example

To demonstrate one of the benefits of using the amorphous sodium aluminate according to embodiments of the present invention, Poly aluminum chlorosulfate (PACS) was made. The PACS was made using the method of U.S. Pat. No. 5,985,234, which is incorporated by reference herein in its entirety. The PACS and control sample were made identically with the control sample being made with commercially available 45% sodium aluminate and the PACS Example was made with the amorphous sodium aluminate of the present invention. PACS have a limited shelf-life and degrade rapidly at temperatures above 100° F. Stable sodium aluminates are believed to produce more stable PACS while unstable sodium aluminates can have storage problems producing a sludge as the material deteriorates. Unstable sodium aluminate can cause the coagulation and flocculation properties of PACS to deteriorate faster in warmer temperatures.

259 grams of 28% aluminum chloride solution was added to a 600-milliliter beaker, in addition to 40 grams of commercially available aluminum sulfate solution. The solution of amorphous sodium aluminate analyzed at
25.1% Al₂O₃
18.3% Na₂O
Mole Ratio (Na₂O:Al₂O₃): 1.201

97 grams of the sodium aluminate solution was sheared into the beaker with an additional 55 grams of water. The milky solution was stirred overnight until it became clear. Portions of this example and the control were incubated in an incubator set at 110° F. for 3 weeks. The control sample was cloudy with a thin layer of precipitate. The sample made with amorphous sodium aluminate according to the present invention was clear with no precipitate.

The incubated samples were jar tested using tap water with small amounts of sodium humate and Kaolin to mimic a type of raw water. The jars of water were dosed with the same amount of PACS and compared.

### Control

25 microliter dosage per 1000 milliliters of test water resulted in a settled turbidity of 3.2 FNUs or 88% removal. Floc was fine sized.

### Amorphous Sodium Aluminate

25 microliter dosage per 1000 milliliters of test water resulted in a settled turbidity of 1.8 FNUs or 93% removal. Floc was large sized.

Although the above discussion discloses various exemplary embodiments, those skilled in the art may make various modifications to, or variations of, the illustrated embodiments without departing from the inventive concepts disclosed herein.

What is claimed is:

1. A method for producing an amorphous sodium aluminate, the method comprising:
providing a solution of sodium hydroxide;
adding aluminum oxide trihydrate, a carbonate and a gluconate to the sodium hydroxide solution to form a second solution; and
heating the second solution to a temperature sufficient to form the sodium aluminate.

2. The method of claim 1, further comprising adding a bicarbonate to the second solution.

3. The method of claim 2, wherein the bicarbonate is sodium bicarbonate, potassium bicarbonate, or combinations thereof.

4. The method of claim 2, wherein the bicarbonate comprises greater than 0 wt % to about 0.1 wt % of the second solution.

5. The method of claim 1, wherein the gluconate comprises about 0.01 wt % to about 0.25 wt % of the second solution.

6. The method of claim 1, wherein the carbonate is sodium carbonate, potassium carbonate, or combinations thereof.

7. The method of claim 1, wherein the carbonate comprises about 0.02 wt % to about 1.0 wt % of the second solution.

8. The method of claim 1, further comprising adding water to the second solution before or after the heating.

9. The method of claim 1, further comprising adding potassium hydroxide to the solution of sodium hydroxide or to the second solution before or after the heating.

10. The method of claim 1, wherein the second solution is heated to near, at or above a boiling point of the second solution.

11. The method of claim 1, wherein the heating of the second solution is between about 230° F. to about 255° F.

12. The method of claim 1, wherein the sodium aluminate has a sodium oxide to aluminum oxide ratio of about 1.190:1 to about 1.622:1.

13. The method of claim 1, wherein the sodium aluminate comprises about 17.5 wt % to about 22.0 wt % sodium oxide.

14. The method of claim 1, wherein the sodium aluminate comprises about 19.4 wt % to about 29.0 wt % aluminum oxide.

15. The method of claim 1, wherein the sodium aluminate comprises about 0.02 wt % to about 1.0 wt % sodium carbonate, about 0.01 wt % to about 0.25 wt % sodium gluconate, and about 0.02 wt % to about 0.1 wt % sodium bicarbonate.

16. An amorphous sodium aluminate produced according to the method of claim 1.

17. A method for producing a stable, low concentration sodium aluminate, the method comprising:
producing the sodium aluminate according to the method of claim 1 having a designated percent concentration; and
adding the sodium aluminate to a solution of water to form a sodium aluminate solution to produce a lower concentration sodium aluminate, the lower concentration sodium aluminate having a lower percent concentration than the sodium aluminate with the designated percent concentration.

18. The method of claim 17, further comprising adding sodium hydroxide and/or potassium hydroxide to the sodium aluminate solution.

19. The method of claim 17, wherein the sodium aluminate has a concentration of about 47% sodium aluminate and the lower concentration sodium aluminate has a concentration ranging from about 38% to about 45% sodium aluminate.

20. A method for producing polyaluminum chlorides (PAC) suitable for use as coagulants in water treatment, the method comprising:
producing the sodium aluminate according to the method of claim 1;
adding the sodium aluminate to a solution of water to form a sodium aluminate solution; and
mixing the sodium aluminate solution with a solution comprising basic aluminum chloride to produce a solution of the PAC.

21. A method for producing polyaluminum chlorosulfates (PACS) suitable for use as coagulants in water treatment, the method comprising:
producing the sodium aluminate according to the method of claim 1;
adding the sodium aluminate to a solution of water to form a sodium aluminate solution; and
mixing the sodium aluminate solution with a solution comprising basic aluminum chlorosulate to produce a solution of the PACS.
